(19) United States
(12) Patent Application Publication
(10) Pub. No.: US 2025/0257153 A1
(43) Pub. Date: Aug. 14, 2025

(54) HIGHLY SOLUBLE TUBER OR CEREAL STARCH AS REPLACER OF MALTODEXTRIN

(71) Applicant: ROQUETTE FRERES, LESTREM (FR)

(72) Inventors: Liuming ZHOU, Geneva, IL (US); Ken JIAN, Naperville, IL (US)

(21) Appl. No.: 18/854,373

(22) PCT Filed: Apr. 5, 2023
(86) PCT No.: PCT/EP2023/025160

§ 371 Date: Oct. 4, 2024

Related U.S. Application Data
(60) Provisional application No. 63/327,882, filed on Apr. 6, 2022.

(51) Int. Cl. C08B 31/00; A23L 27/00; A23L 29/212

(52) U.S. Cl. CPC C08B 31/00; A23L 27/72; A23L 29/212

(57) ABSTRACT

A highly soluble cereal or tuber starch having a content of oligosaccharides with a Degree of Polymerization (DP) of 1 and 2 of less than 7%, a water solubility of more than 90% in weight, a viscosity of less than 50 cP and an α-1,4/α-1,6 ratio between 20 to 25%, a method of preparation thereof, and its use in food applications.

The present invention deals with a highly soluble tuber or cereal starch produced by physical means (clean process), i.e. without addition of any chemicals or enzymes, and its use as maltodextrin alternative for bakery, sauce and dressing, dairy and beverage, more specifically for flavor encapsulation. More preferably, the tuber or cereal starch are respectively potato and corn starches.

Hence, the present invention concerns a process that consists essentially in cooking starch-water mixture and then sonication of the solution obtained in particular conditions.

### STATE OF THE ART

Starch is undeniably the most important polysaccharide in the human diet. It is only second to cellulose in terms of abundance of organic compounds in the biosphere.

The attractiveness of starch usage in the food and non-food industries could be ascribed to its cheapness, abundance, biodegradability and non-toxic nature. Starches are easily obtained from various botanical sources, e.g., cereal, legume, root and tuber and green fruit.

The need for native starch modification is due to the inherent deficiencies in its properties.

Native starches are insoluble in water, easily retrograde with associated syneresis and most significantly gels and pastes produced by native starches are unstable at high temperature, pH and mechanical stress.

Due to these inherent native starch inadequacies, there is need for modification to better the functional and physicochemical properties for suitable industrial applications.

Modification of starches can be broadly divided into physical, chemical, biotechnological and enzymatic or their combinations properly called dual modification.

Amongst them, physical methods are more acceptable since they are general chemical-free and hence considered safer for human consumption.

Physical modification of starch is more connected to the emerging concept of “clean label”, “green technology” or “sustainable technology” for environmentally friendly applications.

Indeed, consumers are demanding more transparency about the ingredients in their foods, driving increased interest in ingredients that meet “clean label” guidelines.

Clean labeling could be any one or more of the following:
Recognizable ingredients
Minimal ingredients
Minimally processed
No artificial ingredients
No preservatives
Non-GMO
All-natural
Organic
Country of origin

Physical modification of starch can improve water solubility and reduce particle size. The methods involve the treatment of starch granules under different temperature/moisture combinations, pressure, shear and irradiation.

Physical modification also includes mechanical attrition to change the particle size of starch granules.

Physical modification techniques are generally given preference as they do not involve any chemical treatment that can be harmful for human use.

The broad classification of starch physical modification into those that are thermal and others that is non-thermal.

The thermal processes involve:
The ones in which the starch granule structures are destroyed (all pre-gelatinization processes), and
The ones in which the granules are preserved (hydrothermal processes: annealing and heat-moisture treatment).

In pre-gelatinization, the granular structure of starch is totally destroyed as a result of heating, there is de-polymerization and fragmentation and so the molecular integrity of the starch is not preserved.

Therefore, pre-gelatinized starches are starches that have undergo gelatinization and consequently are depolymerized, fragmented and the granular structure is entirely destroyed as a result of cooking. The pre-gelatinization process is achieved by drum drying, spray drying and extrusion cooking. The properties associated with pre-gelatinized starches permits instant dissolution in cold water without heating.

Due to the harsh treatment (gelatinization and severe drying) used to obtain pre-gelatinized starches, it is porous, possessed higher water absorption index and water solubility index than that of the native starches.

However, there are certain limitations associated with pre-gelatinized starches which have reduced its applications in certain foods.

These include grainy texture, inconsistent and weak gels. These demerits have been surmounted by the development of granular cold water swelling starch. The latter can exhibit cold water thickening despite keeping its granular integrity, it possesses higher viscosity, more homogeneous texture with higher clarity and has more processing tolerance than pre-gelatinized starches.

Unlike native starch, they can rapidly absorb water and increase their viscosity at ambient temperature. This useful functionality has made them applicable in a range of products synthesized at low temperature containing heat-labile components (e.g., vitamins and coloring agents) and instant food.

Undeniably, the functional and physicochemical properties of various modified starches determine their applications in the food industry.

Unlike pre-gelatinization, annealing and heat-moisture treatment involve heating starch in water at a temperature below the gelatinization temperature (GT) and above the glass transition temperature (Tg). Consequentially, the granular structure of starch is preserved.

The physical non-thermal processes involve methods dealing with the preservation of food as a result of their impact on microbial organisms that cause fermentation.

These are processes that use pressure, ultrasound (US), pulsed electric field (PEF) and radiation to manipulate the physicochemical and functional properties of starches. Ultrasound food processing technology uses frequency in the range of 20 KHz to 10 MHz. Ultrasound is the sound that is above the threshold of the human ear (>18 KHz). It is produced with either piezoelectric or magnetostrictive tranducers that generate high energy vibrations. These vibrations are amplified and transferred to a sonotrode or probe, which is in direct contact with the fluid.

Some merits as a consequent of ultrasound utilization in food processing are processing time reduction, energy efficiency and eco-friendly process. Other advantages of ultrasound are reduction of processing temperature, batch or continuous process can be utilized, increased heat transfer, deactivation of enzymes and possible modification of food structure and texture.

The ultrasound methods have been applied to several kinds of native starch (sweet potato, tapioca, potato and corn) and polysaccharides.

When native corn starch was subjected to High Power Ultrasound (HPU) treatment (24 KHz), the crystalline region of the modified corn starch granules was observed to be distorted.

The best way for molecular weight reduction of polysaccharides such as starch and chitosan is to treat their aqueous solution with 360 KHz US. The degradation of starch by applied ultrasound has been ascribed to OH radical formation and mechanochemical effects.

High power ultrasound is very significant in the following fields of food processing; filtration, crystallization, homogenization, extrusion, de-foaming, viscosity alteration, separation, emulsification and extraction. These unit operations are very important in the separation of gross product into its various components. Other applications of ultrasound include inactivation of enzymes and bacteria by splitting their cell membranes due to the violence of cavitation and the production of free radicals.

Modification of starch is an ever evolving industry with numerous possibilities to generate novel starches which includes new functional and value added properties as demanded by the industry.

In the field of the present invention, the applicants were more particularly interested in the preparation and the use in food applications of maltodextrins.

Maltodextrins are polymers of saccharides that consist of glucose units, primarily linked by α-1,4 glucosidic bounds. These starch derivatives are commonly prepared from corn, rice, potato starch or wheat. Even though they come from plants, they are highly processed.

Maltodextrins are indeed classically obtained from enzymatic hydrolysis with or without acid but to a lower extent than that required to produce starch syrups. Maltodextrins are available in different molecular weights as dextrose equivalent (DE) according to the production method and source. The DE is expressed as a percentage of glucosidic-bound hydrolysis, showing their reducing power.

Maltodextrins provide good oxidative stability to oil encapsulation but exhibit poor emulsifying capacity, emulsion stability and low oil retention. Maltodextrins with DE of 10 to 20 fit in for use as coating materials and show the highest retention of flavor. Moreover, maltodextrins are a good compromise between cost and effectiveness, bland in flavor, have low viscosity at high solids ratio, and aqueous solubility, resulting in their interest, value for encapsulation.

Therefore, maltodextrin is a versatile ingredient in food industrial and has large application in food industries including food and beverage, sauce and dressing, bakery, dairy, flavor encapsulation . . .

However, it is not consumer and Consumer Packaged Goods (CPG) friendly for due to clean label concerns. Indeed, to increase the solubility, classical ways to hydrolyze starch needs acid and/or enzymes to chemically decompose the long chains of starch molecules. The problems associated with those technologies include:
1. Add foreign components into natural materials,
2. High operational costs caused by adding and then removing the foreign components,
3. Additional capital costs for the adding and removing steps.

For that reason, a certain number of alternatives have been developed to produce starch derivatives having functionalities (as solubility) similar to maltodextrin that will have high market potential based on Customer feedback and Marketing strategy.

However, if various commercial products exist like cold-water soluble starch or pre-gelatinized starches, their solubility is often much lower than maltodextrin and therefore cannot substitute the use of maltodextrin.

Therefore, to respect the wishes of the consumers, there is a need in the corresponding field to offer a “clean label” solution.

The Applicant found that the solution goes through the to use physical means for starch hydrolysis, to eliminate the addition of chemical/enzyme, to generate clean label soluble starch, and to meet the customers' demands and market trend on green products.

However, it does not exist in the state of the art very efficient technical alternative way to produce maltodextrin-like products.

The most commonly applied thermal treatment is that used to make pregelatinized starches. As already discussed, these starches have been completely cooked, i.e., pasted, and dried under conditions that allow little or no molecular reassociation. They are described as being cold-water soluble, although many such products will develop additional viscosity upon heating aqueous dispersions of them.

Nevertheless, even if the resulting pregelatinized starches are more soluble, this solubility is low, usually less than 50%, far from that of maltodextrins.

Depolymerisation also occurs during the pregelatinisation processes. The molecular weights of starch amylose and amylopectine usually decrease by factors 1.5 and 2.5 respectively. However, this thermal process needs high temperature treatment (>140° C. during 2 to 12 hours) and the heated starch solution obtained contains high concentration of compounds presenting a low degree of polymerization (DP) content (D<6).

Physical non-thermal processes have been developed in that perspective: microwave, milling or sonication directly on native starch.

However, the heating of aqueous slurry of starch granules using microwaves is difficult to implement on an industrial scale.

The milling mechanically reduces particle sizes of starch granules to less than 20 micrometers, but it is very energy-intensive consumption. Furthermore, it is not possible to achieve the desired solubility.

Ultrasound treatment of native starch generates cavitation and radiations to decompose starch molecules. Ultrasonic depolymerization is a nonrandom process where chain scissions near the center of largest molecules are favored.

Ultrasonic degradation of a polymer leads to control of molecular weight, but needs long processing time and extra strong intensity, which limits the processing efficiency.

Moreover, this ultrasonic treatment has two main constraints, as presented by Isono et al, in their paper entitled Ultrasonic degradation of waxy rice starch, 1994, in Biosci. Biotech. Biochem., 58, 1779-1802:
Choice of waxy rice starch because of its solubility in (hot) water
Drive the sonication at a temperature of 60° C. to promote the reaction at a temperature where gelatinization starts, and because of the difficulty in temperature control and loss of water at higher temperatures.

A proposed promising technology was to combine sonication and gelatinization of starch. However, the aim was, as described by lida et al, in their paper entitled Control of viscosity in starch and polysaccharide solutions with ultrasound after gelatinization, 2008, in Innovative Food Sciences and Emerging Technologies 9, 140-146, to reduce viscosity of pre-gelatinized starch for spray drying. The gelatinization process is thus conducted at a temperature less than 95° C. following by ultrasonic irradiation applied for 30 minutes, and produce:
Starch with improved solubility for spray drying,
Starch solubility improved at higher solution temperature (≥65 C), but not in cold water (the cold water solubility (water at around 20° C.) of the product is less than 30%).
   Therefore, there is still a very strong interest in seeking new processing methods for producing alternatives to maltodextrin.

### SUMMARY OF THE INVENTION

In a first aspect the invention relates to a highly soluble tuber starch or cereal starch having:
A content of oligosaccharides with aDegree of Polymerization (DP) of 1 and 2 of less than 7%,
A water solubility of more than 90% in weight,
A viscosity of less than 50 cP,
A α-1,4/α-1,6 ratio between 20 to 25%.

The cereal starch is preferably corn starch. The tuber starch is preferably potato starch.

In a second aspect, the invention relates to a method of preparation of a highly soluble tuber or cereal starch, said method comprising the steps of:
a. Preparing a starch-water mixture containing tuber starch or cereal starch,
b. Cooking of the slurry at high temperature,
c. Sonicating the cooked slurry.

The tuber starch or cereal starch advantageously represents 5 to 20% by weight with respect to the total weight of the starch-water mixture.

The cooking of the slurry is preferably performed at a temperature between 100 to 200° C., more preferably at a temperature around 160° C.

The cooked slurry is preferably sonicated at a frequency between 10 to 50 kHz, at a temperature between 30 to 80° C., more preferably is sonicated at a frequency of 15 to 25 kHz, more preferably at 20 kHz, at a temperature between 40 to 45° C.

The method of the invention preferably further comprises a step d. of evaporating the sonicated slurry to obtain a syrup or drying the sonicated slurry to obtain a powder product.

In the method of the invention, the tuber starch is preferably potato starch. The cereal starch is preferably corn starch.

In a third aspect, the invention relates to the use of the highly soluble tuber or cereal starch of the invention in food applications as an alternative to maltodextrin, preferably for the preparation of bakery, sauce and dressing, dairy and beverage, more preferably for flavor encapsulation (as carrier for flavor encapsulation). It can also be used in the formulation of fat free vinaigrette or for the preparation of powder beverage formulations such as tropical punch mix or energy beverage.

### DETAILED DESCRIPTION OF THE INVENTION

In a first aspect, the invention relates to highly soluble tuber or cereal starch having:
A content of oligosaccharides with a Degree of Polymerization (DP) of 1 and 2 of less than 7%,
A water solubility of more than 90% in weight,
A viscosity of less than 50 cP,
An α-1,4/α-1,6 ratio between 20 to 25%.

With such a profile (which, to the Applicant's knowledge, has never been described), the highly soluble tuber or cereal starch according to the invention have a profile equivalent to maltodextrin (in terms of DP content, solubility, viscosity and structure).

The measure of the content of oligosaccharides with a Degree of Polymerization (DP) of 1 and 2 (total of % DP1+% DP2) and of 3 to 20; is typically determined by the industrial standard carbohydrates analysis method.

High pressure liquid chromatograph with ion-exchange resin in silver form, such as AMINEX HPX-42A resin, may be employed.

Area at certain retention time corresponding to an individual DP value is recorded; the percentage of each particular DP is calculated as:

% DP=Individual DP Area/Summation of all DP Areas

The highly soluble tuber starch is preferably potato starch.
The highly soluble cereal starch is preferably cereal grain starch. Preferably the cereal is corn.

The highly soluble corn or potato starches has a content of oligosaccharides with a Degree of Polymerization (DP) of 1 and 2 of less than 7% i.e. has a content of oligosaccharides such that the total of % DP1 and % DP2 is less than 7%.

By comparison, the maltodextrin GLUCIDEX® 12 commercialized by the Applicant has a content of oligosaccharides of DP1 and DP2 of about 7% and a content of oligosaccharides with a DP of 3 to 20 of about 91%.

According to the present invention, the term “highly soluble starch” refers to a starch having a water solubility (water at around 20° C.) of more than 90% in weight, more preferably more than 93%.

The water solubility may be determined by the method given in Example 1.

The high solubility corn or potato starch presents a water solubility of more than 90% in weight.

By comparison, the maltodextrin GLUCIDEX® 12 presents a water solubility of more of about 93%.

The viscosity may be measured by the method given in Example 1.

The high solubility tuber or cereal starch presents a viscosity of less than 50 cP.

By comparison, the maltodextrin GLUCIDEX® 12 presents a viscosity of less about 600 cP.

The highly soluble tuber or cereal starch of the invention has then acquired the conventional maltodextrin structure.

It can be illustrated by the α1,4/α1,6 ratio of the macromolecule, determined by RMN ¹³C.

The RMN ¹³C methodology followed is based on the work of:
Gidley, Michael J. (1985) in Carbohydrate Research, 139, 85-93.
Schmitz, Sarah. (2009) in Macromolecular Bioscience, 9, 506-514
Tizzotti, Morgan J. (2011). Journal of Agricultural and Food Chemistry, 59, 13, 6913-6919.

The procedure is the following:
1. Weight 10±0.05 mg starch sample.
2. Add 1.0 mL of anhydrous DMSO-d6 contained 0.5% (w/w) LiBr to the sample.
3. Add a tiny stir bar into the mixture and incubate the sample overnight at 80° C. and 300 rpm.
4. Cool the sample to room temperature.
5. Add 0.5 mL of sample mixture to the NMR tube.
6. Add 5.66 μL of deuterated trifluoroacetic acid (d1-TFA) to the medium just before the NMR measurement.
7. Analyze the sample with 1H NMR, obtain the 1H NMR spectra at 70° C.:

The conditions:
Larmor frequency of 500.13 MHz
12 μs 30° pulse
A repetition time of 15.07 s
An acquisition time of 3.07 s
A relaxation delay of 12 s
300 scans.

For the measurements:
α-1,4 linkages: peak intensity at 5.11 ppm,
α-1,6 linkages: peak intensity at 4.75 ppm

So, the high soluble tuber or cereal starch of the invention has an α-1,4/α-1,6 ratio between 20 and 25%.

By comparison:
native corn starch presents a typical α-1,4/α-1,6 ratio of about 29% to 30%
native potato starch presents a typical α-1,4/α-1,6 ratio of about 30% to 32%
GLUCIDEX® 12 has a α-1,4/α-1,6 ratio of about 22% to 23%

Such product can be advantageously used in food application such as for flavor encapsulation.

The highly soluble tuber or cereal starch may be in the form of a powder or of a syrup.

In a second aspect, the invention relates to a method of preparation of a highly soluble tuber starch or cereal starch that comprises or consists in:
a. Preparing a starch-water mixture containing tuber starch or cereal starch,
b. Cooking of the slurry at high temperature,
c. Sonicating the cooked slurry,
d. Optionally, evaporating the sonicated slurry to obtain a syrup or drying the sonicated slurry to obtain a powder product.
   The highly soluble tuber starch or cereal starch is preferably as defined in the first aspect of the invention.

### Step a: Preparation of a Starch-Water Mixture.

Target: to prepare a slurry containing starch at 5 to 20% by weight with respect to the total weight of the slurry.

Starch used in that step may be from various botanical sources of cereal or tuber, more preferably are from corn or potato.

The slurry is then preferably stirred at 15 to 16° C. for 10 to 20 min.

### Step b: Cooking of the Slurry

This cooking step or further heating treatment can be carried out at a temperature between 100 to 200° C.

With com or potato starch, the cooking is preferably performed at a temperature between 150 and 170° C., typically of about 163° C.

### Step c: Sonication of the Cooked Slurry

The sonication can be performed at a frequency between 10 to 50 kHz, at a temperature between 30 to 80° C.

With corn or potato starch, the sonication is preferably performed at a frequency of 15 to 25 kHz, more preferably at 20 kHz, at a temperature between 40 to 45° C., for 10 to 20 minutes.

The sonicated slurry may optionally be refined.

Step d: Evaporation as a Syrup or Drying into Powder Form

The resulted product can be evaporated as syrup or dried into powder form using methods well known in the art. The drying may be carried out in a dryer such as a drum dryer, a flash dryer, a spray dryer, or a freeze dryer.

The product obtained:
is cold water soluble, i.e. has a water solubility ≥90% around 20° C.,
has properties similar to maltodextrin (oligosaccharides DP2-DP20 content >50%),
is clean label (no chemical additives).
   In a third aspect, the invention concerns the use of highly soluble tuber or cereal starch according to the invention in food applications as an alternative to maltodextrin, preferably for the preparation of bakery, sauce and dressing, dairy and beverage.
   It may also be used as a carrier for flavor encapsulation, for example for the formulation of fat free vinaigrette or for the preparation of powder beverage formulations such as tropical punch mix or energy beverage.

### EXAMPLE

This invention will be better understood in light of the following examples which are given for illustrative purposes only and do not intend to limit the scope of the invention, which is defined by the attached claims.

### Example 1

### Preparation of the Soluble Corn or Potato Starch According to the Invention

### Material and Equipment

Raw material: Native corn and potato starches (commercialized by the Applicant),
Pressure cooker: Parr pressure reactor 8500
Ultrasonic equipment: Qsonica Q2000

### Process, Piloting Procedure and Operating Conditions

### Process

Corn or potato starch is mixed in the mixing tank and cooked in pressure reactor. After cooking, the solution was sonicated, then freeze dried to form highly soluble corn or potato starch powder.

### Piloting Procedure and Operating Conditions

The steps of the piloting procedure and related operating conditions are listed below:
Mix 1,000 g of corn or potato starch powder with 9,000 g tap water to form 10,000 g of a starch-water mixture having a starch concentration of 10% by weight of mixture.
The mixture was stirred in the mixing tank at 15.5° C. for 15 minutes,
Cook the mixture at 163° C. for 30 minutes,
Cool down the cooked solution to 50° C.
Sonicate the solution at 90% intensity, 45° C. and 20 KHz frequency for 15 minutes.
Freeze dry at −80° C.

### Sample Analysis

### Water Solubility Measurement

deposit 45 ml of a sample in 50 ml centrifuge tube at room temperature.
Centrifuge the sample at 3000 g for 5 minutes.
Supernatant was collected and weighted.
Dry the supernatant at 130° C. for two hours until constant weighting.
Cool the dried supematant in desiccator at room temperature (i.e. at about 20° C.) for 1 hour.
Calculate the water solubility was by the formula:

$${100}^{*} {m}^{*} ( M + P ) / ( P {1}^{*} P )$$

where: M=mass of water, P=mass of starch, P1=mass of supernatant,
m=mass of dried residual.
   In the Examples, Water Solubility measurements were repeated twice for accuracy.

### Dextrose Equivalent and Carbohydrate Profile Measurements

Dextrose equivalent (DE) of pilot samples were determined by method well known in the art, such as the Lane-Eynon Titration method.
The carbohydrate profiles were determined by HPLC with double-silver column.

### Viscosity Measurement

Dissolve pilot products in deionized (DI) water at room temperature to form solutions with different concentrations.
Viscosity of the solutions was measured with Brookfield Il viscometer using a #21 spindle.
Temperature of the solutions were controlled with circulated water bath.

### Results and Discussion

### Dextrin Equivalent and Carbohydrate Profile

Dextrin equivalent (DE) and carbohydrate profile (DP) are important information about the pilot product properties.

To be labeled as soluble starch, the product must be soluble in cold water (water at around 20° C.) and contain low DP1 and DP2 concentration as well.

Table 1 is the results of DE and DP measurements of the pilot products, with different batches. DE and DP results of commercial maltodextrin with DE12 (GLUCIDEX® 12 commercialized by the applicant) are also included in the table as comparison.

TABLE 1
Results of DE and DP measurements (in %):

| | PS-100820 | PS-101320 | |
|---|---|---|---|
| Properties | Corn starch | Potato starch | GLUCIDEX ® 12 |
| DE | 7.78 | 14.53 | 10.16 |

Carbohydrate profile (%)

| | | | |
|---|---|---|---|
| Fructose | 0.19 | 0.36 | 0.00 |
| Glucose | 0.37 | 3.10 | 0.51 |
| Maltose | 0.73 | 3.09 | 2.33 |
| DP3 | 0.96 | 3.50 | 3.83 |
| DP4 | 1.22 | 3.94 | 3.24 |
| DP5 | 1.32 | 3.71 | 3.46 |
| DP6 | 0.96 | 3.25 | 4.36 |
| DP7 | 3.79 | 6.20 | 4.28 |
| DP8-DP20 | 19.05 | 22.56 | 24.93 |
| DP21+ | 70.93 | 50.29 | 53.07 |
| DP1 + DP2 | 1.29 | 6.55 | 2.84 |

The results indicate that the pilot products have DE values around 8 for the highly soluble corn starch, and around 14.5 for the highly soluble potato starch; and have DP1+DP2 concentration respectively of about 1% and 6.5%.

### Solubility

Another important property parameter is solubility.

The corn or potato starch powder is dissolved in water at different concentrations (in wt %).

The results are presented in the following Table 2.

TABLE 2

| | Concentration | Solution | | | | Supernatant | | | | Solubility |
|---|---|---|---|---|---|---|---|---|---|---|
| Sample | (%) | Empty | Wet | Dry | DS (%) | Empty | Wet | Dry | DS (%) | (%) |
| Corn-15 | 15.0 | 2.2588 | 6.8467 | 2.8942 | 13.85 | 2.2265 | 7.0699 | 2.8951 | 13.80 | 99.67 |
| Corn-25 | 25.0 | 2.2401 | 7.4419 | 3.4345 | 22.96 | 2.2551 | 6.9679 | 3.3093 | 22.37 | 97.42 |
| Corn-35 | 35.0 | 2.2455 | 7.1608 | 3.8335 | 32.31 | 2.2627 | 7.5178 | 3.8515 | 30.23 | 93.58 |
| Potato-15 | 15.0 | 2.2730 | 7.3363 | 2.9966 | 14.29 | 2.2460 | 7.2187 | 2.9557 | 14.27 | 99.87 |
| Potato-25 | 25.0 | 2.2521 | 7.5914 | 3.5357 | 24.04 | 2.2065 | 7.9014 | 3.5689 | 23.92 | 99.51 |
| Potato-35 | 35.0 | 2.2600 | 7.7975 | 4.1349 | 33.86 | 2.2147 | 7.7255 | 4.0450 | 33.21 | 98.09 |

The result indicates that the corn and potato starch of the invention have enough solubility in cold water to be used as an alternative to maltodextrin.

### Viscosity

Viscosity directly affects the product applicability and processing-ability; it also reflects the effects of processing conditions on the final products. Currently, viscosity of the commercial maltodextrin with DE12 (GLUCIDEX® 12) sample is used as reference.

The results are presented in the following Table 2.

Table 3 and Table 4 show the measurement results of pilot product samples and the reference one.

TABLE 3

| | | | | | Shear | Shear | |
|---|---|---|---|---|---|---|---|
| | Concentration | Viscosity | Speed | Torque | stress | rate | Temp. |
| Sample | (%) | (cP) | (rpm) | (%) | (D/cm²) | (sec⁻¹) | (° C.) |
| Corn soluble | 15.0 | 10 | 100 | 1.0 | 9.30 | 93 | 24 |
| starch of the | 25.0 | 14 | 100 | 1.4 | 13.02 | 93 | 24 |
| invention | 35.0 | 43 | 100 | 4.3 | 40.02 | 93 | 24 |
| Potato soluble | 15.0 | 8 | 100 | 0.8 | 7.44 | 93 | 24 |
| starch of the | 25.0 | 10 | 100 | 1.0 | 9.30 | 93 | 24 |
| invention | 35.0 | 25 | 100 | 2.5 | 23.23 | 93 | 24 |
| Water | | 6 | 100 | 0.6 | 5.58 | 93 | 24 |

The result indicates that the corn and potato starches of the invention have similar rheology behavior.

### Comparative Studies

The data are presented in the following Table 4:

TABLE 4

| | | | | DP1 and | DP3 | |
|---|---|---|---|---|---|---|
| | | | α-1,4/α-1,6 | DP2 | and | |
| Sample | Solubility | Viscosity | ratio | content | higher | DE |
| Native corn starch | <2% | | 29-30% | 0.0% | / | / |
| commercialized | | | | | | |
| by the Applicant | | | | | | |
| Highly soluble | >93% | 10-43 cP | 22-23% | 1-1.5% | >95% | 8 |
| corn starch of the | | | | | | |
| present invention | | | | | | |
| Native potato | <2% | | 30-32% | 0.0% | / | / |
| starch | | | | | | |
| commercialized | | | | | | |
| by the Applicant | | | | | | |
| Highly soluble | >93% | 8-25 cP | 20-21% | 6-7% | >90% | 14.5 |
| potato starch of | | | | | | |
| the present | | | | | | |
| invention | | | | | | |
| GLUCIDEX ® 12 | >93% | <600 cP | 22-23% | 3-7% | >90% | 12 |
| commercialized | | | | | | |
| by the Applicant | | | | | | |

It is clear that the highly soluble corn and potato starches of the invention are functionally and structurally similar to maltodextrins.

1. A highly soluble tuber starch or cereal starch having:
a content of oligosaccharides with a Degree of Polymerization (DP) of 1 and 2 of less than 7%,
a water solubility of more than 90% in weight,
a viscosity of less than 50 cP,
a a-1,4/α-1,6 ratio between 20 to 25%.

2. The highly soluble starch according to claim 1, wherein the cereal starch is corn starch.

3. The highly soluble starch according to claim 1, wherein the tuber starch is potato starch.

4. A method of preparation of a highly soluble tuber or cereal starch, said method comprising the steps of:
a. preparing a starch-water mixture containing tuber starch or cereal starch,
b. cooking of the slurry at high temperature,
c. sonicating the cooked slurry.

5. The method according to claim 4, wherein the tuber starch or cereal starch represents 5 to 20% by weight with respect to the total weight of the starch-water mixture.

6. The method according to claim 4, wherein the cooking of the slurry is performed at a temperature between 100 to 200° C.

7. The method according to claim 4, wherein the cooking of the slurry is performed at a temperature around 160° C.

8. The method according to claim 4, wherein the cooked slurry is sonicated at a frequency between 10 to 50 kHz, at a temperature between 30 to 80° C.

9. The method according to claim 4, wherein cooked slurry is sonicated at a frequency of 15 to 25 kHz, more preferably at 20 kHz, at a temperature between 40 to 45° C.

10. The method according to claim 4, wherein the method further comprises a step d. of evaporating the sonicated slurry to obtain a syrup or of drying the sonicated slurry to obtain a powder product.

11. The method according to claim 4, wherein the tuber starch or cereal is potato starch or corn starch.

12. A use of the highly soluble tuber or cereal starch according to claim 1 in food applications as an alternative to maltodextrin.

13. The use according to claim 12, for the preparation of bakery, sauce and dressing, dairy and beverage.

14. The use according to claim 12, as carrier for flavor encapsulation.

15. A use of the highly soluble tuber or cereal starch according to claim 1 for the formulation of fat free vinaigrette or for the preparation of powder beverage formulations.
